(19) United States
(12) Patent Application Publication
(10) Pub. No.: US 2018/0232735 A1
(43) Pub. Date: Aug. 16, 2018

(54) METHODS AND SYSTEMS FOR AUTHENTICATING TRANSACTIONS

(71) Applicant: Twilio, Inc., San Francisco, CA (US)

(72) Inventor: Daniel Palacio, San Francisco, CA (US)

(21) Appl. No.: 15/950,066

(22) Filed: Apr. 10, 2018

Related U.S. Application Data
(63) Continuation of application No. 14/620,072, filed on Feb. 11, 2015.
(60) Provisional application No. 61/938,366, filed on Feb. 11, 2014.

(51) Int. Cl. G06Q 20/40

(52) U.S. Cl. CPC G06Q 20/401

(57) ABSTRACT

A method for verifying transactions initiated by an electronic request from a consumer includes receiving at a processing device a transaction initiated by the consumer on a first electronic device, transmitting the received transaction to a party responsible for completing the transaction, transmitting transaction details to complete the transaction to a pre-registered electronic device that is configured to facilitate completing the transaction, and completing the transaction after receiving a verification signal from the preregistered electronic device.

### CROSS REFERENCE TO RELATED APPLICATIONS

This application is a continuation of U.S. patent application Ser. No. 14/620,072, filed 11 Feb. 2015, which claims the benefit of U.S. Provisional Application No. 61/938,366, filed 11 Feb. 2014, the entirety of which is incorporated by reference herein.

### FIELD OF THE INVENTION

The invention relates generally to the field of secure electronic transactions, and, more specifically the use of a secondary notification that is used to confirm the transaction.

### BACKGROUND

The proliferation of web-based ecommerce sites in the 1990's and 2000's, followed by the explosive adoption of smartphones in more recent years has allowed consumers to transact business quicker, easier and from virtually anywhere. Along with this newfound convenience, has come certain risks. Initially, transactions sent via the internet were far from secure, and the data sent could be easily intercepted and used nefariously. Rapid adoption of certain authentication and encryption standards eased these fears, and executing financial transactions via the web and wireless devices has become the norm.

However, while the data may be more secure, the user interactions and endpoints (e.g., the browser or phone application) remains a weak point in the process, where vulnerabilities can be exploited. For example, malware placed on a user's computer can capture transaction data prior to encryption and transmission and forward that information to bad actors, who either use the information for their own gain or sell the information on a black market. Other, less sophisticated techniques prey on the naiveté of the consumers through “phishing” whereby fake emails or messages are sent to users who, while believing the messages are from their bank or credit card company, unsuspectingly provide account and authentication information.

What is needed, therefore, is a technique and system that allows users to validate electronic transactions in a manner that reduces or even eliminates these threats.

### SUMMARY OF THE INVENTION

Various embodiments of the present invention provide techniques and supporting systems for facilitating a secure process by which service providers can verify transactions initiated via an electronic request from a consumer. In summary, the transaction is initiated by the consumer on an electronic device (e.g., a desktop computer, laptop, pad device, smartphone, etc.) and sent to the institution responsible for effecting the transaction, typically an ecommerce website, a bank, brokerage, domain name registrar, government website, credit card company, etc. An out-of-band message that includes the transaction details is generated by the institution and sent to the consumer who can compare the details of the transaction they initiated with the transaction proposed to be executed. If they differ in any way, or if no transaction was ever requested, the consumer can reject the transaction.

As an example, if the executing institution is a bank, then a transaction may be instructions to send money via wire transfer. The wire transfer includes a set of specific data and actions the customer would like to execute, typically moving $X dollars to Y account on a specific date. Similarly, if the external service is a domain registrar, a customer might want to instruct the registrar to transfer domain X to Y person.

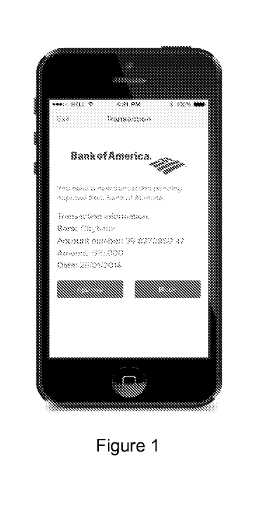

The invention provides an application platform and system for use by the financial or ecommerce institutions that review the incoming transaction requests and generate an out-of-band confirmation message that is sent to the consumer. The devices are registered with the service and have been previously provisioned with a signing key. Upon receipt by the consumer, the signed transaction is then sent back to the institution which uses a corresponding verification key or keys to check the signatures of the transaction. Only once the all the signatures are verified is that the transaction is executed. FIG. 1 below shows an exemplary screen capture of a message received by a consumer to sign and verify a wire transfer request initiated at a physical branch.

A customer goes to a Bank of America branch on Union Square and asks to initiate a wire transfer to move $10,000 to account 39-827395047 on Jan. 25, 2014. Bank of America receives the wire transfer request, but does not immediately execute the wire transfer. Instead, the bank, using the techniques disclosed herein, sends the transaction details to the customer at one or more of their previously registered and configured devices, in this case a smartphone. Upon receiving the message, the customer is informed that he needs to sign the transaction before it's executed. The customer opens the Bank Of America mobile app, and is presented with details of the transaction. Because his mobile device has been configured to sign transactions, and the app includes the signature functionality, clicking approve will add the consumer's private signature to the transaction, which is then sent back to Bank of America. The bank uses their verification key to check that the transaction signature is valid, accepts the signed transaction, and executes it.

The initial transaction, which is not signed, can be discarded. The customer makes the final decision on whether to sign the transaction presented on his device. Moreover, all relevant details of the transaction are presented on a specific out-of-band device and are also sent back to the bank. This is different than conventional methods of sending simple email confirmations with the transaction details which can be opened on any unauthenticated device or simply sending a confirmation back without signing the whole transaction.

In another example, a domain name registrar may wish to confirm a domain transfer request using multiple signers. In this case, a customer goes to the registrar such as GoDaddy and requests that his domain www.google.com be transferred to a buyer with an e-mail address of owner@google.com. GoDaddy receives this transaction request, but because this account requires confirmation using the described methods and multiple keys, GoDaddy does not immediately execute the transfer request. Instead GoDaddy sends this transaction to each of the key owners' devices for signature. In this example, each of the owners of the keys is informed of the transaction request and that for execution it must be signed. Each party opens a signing app on their own devices and signs the transaction independently. The transaction is then sent back to GoDaddy, which uses the verification keys to verify that the signatures are valid. Once all the signatures are verified, GoDaddy executes the transaction.

In this example, the signing parties can be notified via different means such as e-mail, push-notification, SMS or other. Each signing key is also independent of the other keys, the bank only holds the verification keys, and each party to the transaction has an opportunity to digitally sign off on the transaction independent of the initial request.

In each of the examples above, the initial transaction request is “held” and not immediately executed until a signed, verified message is received back from the initiating party through an out-of-band pathway. This effectively separates the initial transaction from the confirmation, making interception and modification of the transaction very difficult.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or other non-transitory storage medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CDROM and DVD-ROM disks. The processor and the memory can be supplemented by, or incorporated in special purpose logic circuitry.

The techniques and system architecture described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method comprising:
a processing device of a hardware transaction verification system registering a first electronic device of a first consumer, provisioning the first electronic device with a first signing key, generating a first verification key for the first signing key, and storing the first verification key at the hardware transaction verification system, the first electronic device being external to the hardware transaction verification system;
the processing device receiving first transaction details of a first transaction from a second electronic device of the first consumer, the second electronic device being external to the hardware transaction verification system;
responsive to the first transaction details provided by the second electronic device, the processing device generating a first out-of-band confirmation message that includes the first transaction details, and sending the first out-of-band confirmation message to the first electronic device;
the processing device receiving a signed confirmation message from the first electronic device via an out-of-bound pathway, the signed confirmation message being generated by the first electronic device by signing the first out-of-band confirmation message by using the first signing key of the first electronic device;
the processing device verifying a signature of the signed confirmation message by using the first verification key; and
responsive to the processing device determining that the signature is verified, the processing device executing the first transaction.

2. The method of claim 1, wherein the first electronic device is a smartphone that includes a signing application, wherein the first electronic device stores the first signing key, and wherein the second electronic device is one of a desktop computer, a laptop, a pad device, and a smartphone.

3. The method of claim 1, wherein the hardware transaction verification system is an ecommerce transaction verification system and wherein the first transaction is an ecommerce transaction.

4. The method of claim 1, wherein the hardware transaction verification system is a brokerage transaction verification system and wherein the first transaction is a brokerage transaction.

5. The method of claim 1, wherein the hardware transaction verification system is a government transaction verification system and wherein the first transaction is a government transaction.

6. The method of claim 1, wherein the hardware transaction verification system is a credit card transaction verification system and wherein the first transaction is a credit card transaction.

7. The method of claim 1, wherein the hardware transaction verification system is a bank transaction verification system and wherein the first transaction is a bank transaction.

8. The method of claim 1, wherein the hardware transaction verification system is a bank transaction verification system and wherein the first transaction is a wire transfer transaction.

9. The method of claim 8, wherein the first transaction details specifies a wire transfer amount, a wire transfer recipient account, and a wire transfer date.

10. The method of claim 1, wherein the hardware transaction verification system is a domain name registrar transaction verification system and wherein the first transaction is a domain name registrar transaction.

11. method of claim 1, wherein the hardware transaction verification system is a domain name registrar transaction verification system and wherein the first transaction is a domain name transfer transaction.

12. The method of claim 12, wherein the first transaction details specifies a domain name and a recipient identifier.

13. The method of claim 12, wherein the recipient identifier is an e-mail address.

14. The method of claim 1, further comprising:
a signing application of the first electronic device controlling the first electronic device to display the first out-of-band confirmation message on a display device of the first electronic device; and
responsive to the first electronic device receiving a transaction approval input for the displayed confirmation message via the signing application, the signing application controlling the first electronic device to generate the signed confirmation message by signing the first out-of-band confirmation message with the first signing key of the first electronic device.

15. The method of claim 14,
wherein the first electronic device is a smartphone,
wherein the signed confirmation message includes signed first transaction details,
wherein the signed first transaction details includes each detail of the first transaction details,
wherein the signed first transaction details are signed with the first signing key.

16. The method of claim 1,
wherein the signed confirmation message includes signed first transaction details,
wherein the signed first transaction details includes each detail of the first transaction details, and
wherein the signed first transaction details are signed with the first signing key.

17. A method comprising:
a processing device of a hardware transaction verification system registering a first electronic device of a first consumer, provisioning the first electronic device with a first signing key, generating a first verification key for the first signing key, and storing the first verification key at the hardware transaction verification system, the first electronic device being external to the hardware transaction verification system;
the processing device receiving first transaction details of a first transaction from the first electronic device;
responsive to the first transaction details provided by the first electronic device, the processing device generating a first out-of-band confirmation message that includes the first transaction details, and sending the first out-of-band confirmation message to the first electronic device;
the processing device receiving a signed confirmation message from the first electronic device via an out-of-bound pathway, the signed confirmation message being generated by the first electronic device by signing the first out-of-band confirmation message by using the first signing key of the first electronic device;
the processing device verifying a signature of the signed confirmation message by using the first verification key; and
responsive to the processing device determining that the signature is verified, the processing device executing the first transaction.

18. The method of claim 17, further comprising:
a signing application of the first electronic device controlling the first electronic device to display the first out-of-band confirmation message on a display device of the first electronic device; and
responsive to the first electronic device receiving a transaction approval input for the displayed confirmation message via the signing application, the signing application controlling the first electronic device to generate the signed confirmation message by signing the first out-of-band confirmation message with the first signing key of the first electronic device.

19. The method of claim 18,
wherein the first electronic device is a smartphone,
wherein the signed confirmation message includes signed first transaction details,
wherein the signed first transaction details includes each detail of the first transaction details, and
wherein the signed first transaction details are signed with the first signing key.

20. The method of claim 19,
wherein the signed confirmation message includes signed first transaction details,
wherein the signed first transaction details includes each detail of the first transaction details, and
wherein the signed first transaction details are signed with the first signing key.
